(19) United States
(12) Patent Application Publication
(10) Pub. No.: US 2023/0371559 A1
(43) Pub. Date: Nov. 23, 2023

(54) METHOD FOR SUPPRESSING COLORING OF OIL/FAT COMPOSITION

(71) Applicant: J-OIL MILLS, Inc., Tokyo (JP)

(72) Inventors: Seika ENOKIDA, Tokyo (JP); Koji IWABUCHI, Tokyo (JP); Junko ARAI, Tokyo (JP); Kazuhisa MIZUNO, Tokyo (JP)

(21) Appl. No.: 18/247,901

(22) PCT Filed: Oct. 18, 2021
(86) PCT No.: PCT/JP2021/038432

§ 371 Date: Apr. 5, 2023

(30) Foreign Application Priority Data
Oct. 19, 2020 (JP) 2020-175130

(51) Int. Cl. A23L 5/10; A23L 29/219; A23L 5/49

(52) U.S. Cl. CPC A23L 5/11; A23L 29/219; A23L 5/49

(57) ABSTRACT

The present invention provides a method for suppressing coloring of an oil/fat composition for frying by covering a food material to be fried with a starch composition. Specifically, the present invention is the method for suppressing the coloring of the oil/fat composition for frying during the frying of the food material, the method being characterized by applying, to the food material, a coating treatment for covering the food material with a coating material containing a starch composition. The present invention can suppress the coloring of the oil/fat composition for frying and can extend the use life of the oil/fat composition for frying.

### TECHNICAL FIELD

The present invention relates to a method for suppressing coloring of oil/fat compositions for deep-frying.

### BACKGROUND ART

During deep-frying, coloring of an oil/fat composition is unavoidable. Coloring of the oil/fat composition can worsen by heating alone but it is also known that coloring significantly worsens when food ingredients (food materials) are deep-fried.

Coloring of the oil/fat composition adversely affects the flavor and color of the deep-fried foods. It is also desirable from a cost perspective to suppress the coloring of oil/fat compositions to extend their useful life.

Patent literature 1 describes addition of at least one selected from raw oils and intermediate oils/fats to an edible oil/fat to give a phosphorus content of 0.1-10.0 ppm in order to suppress coloring and heating odors that occur during heating.

Patent literature 2 describes use of dredging-type seasoned fry mix powder, which contains 20 parts by mass or more and 50 parts by mass or less of a pregelatinized starch, 20 parts by mass or more and 50 parts by mass or less of corn grits, and 5 parts by mass or more and 20 parts by mass or less of fine breadcrumbs, can suppress contamination of the frying oil and improve the yield rate.

Patent literature 3 describes that by containing sucralose in the composition for deep-fried foods, deep-fried foods can be obtained without excessive coloring, such as burning, and without the deep-fried foods sticking to each other.

### CITATION LIST

### Patent Literature

Patent literature 1: Japanese Unexamined Patent Application Publication No. 2009-55897

Patent literature 2: Japanese Unexamined Patent Application Publication No. 2012-95595

Patent literature 3: Japanese Unexamined Patent Application Publication No. 2003-235483

### SUMMARY OF INVENTION

### Technical Problem

However, according to the method of suppressing coloring described in Patent literature 1, the composition of the oil/fat composition is controlled.

Patent literature 2 only describes that dredging-type seasoned fry mix powder is more likely to fall off in the frying oil and cause contamination of the frying oil compared to the water-dissolving-type seasoned fry mix powder, and neither describes nor suggests about coloring of oil/fat compositions caused by deep-frying.

In addition, Patent literature 3 describes that the inclusion of sucralose in the composition for deep-fried foods suppressed the coloring of the deep-fried foods themselves and prevented the deep-fried foods from sticking to each other, but pays no attention to the coloring of the oil/fat composition used for deep-frying at all, and neither describes nor suggests any solution to this problem.

Under these circumstances, the present invention provides a method for suppressing coloring of an oil/fat composition for deep-frying by coating a food ingredient to be deep-fried with a coating agent containing a starch composition.

### Solution to Problem

As a result of diligent study, the present inventors have found that coloring of an oil/fat composition for deep-frying can be suppressed by coating a food ingredient to be deep-fried with a coating agent containing a starch composition, thereby accomplishing the invention.

The present invention is as follows.
[1] A method for suppressing coloring of an oil/fat composition for deep-frying upon deep-frying a food ingredient, the method comprising a step of:
   performing a coating treatment in which the food ingredient is coated with a coating agent containing a starch composition.
[2] The method according to [1] above, wherein the starch composition comprises an oil/fat-modified starch.
[3] The method according to [2] above, wherein the oil/fat-modified starch is one or two or more selected from the group consisting of an oil/fat-modified distarch phosphate tapioca starch, oil/fat-modified acetylated tapioca starch, and oil/fat-modified acetylated distarch phosphate tapioca starch.
[4] The method according to any one of [1] to [3] above, wherein the coating agent contains the starch composition in a quantity of 0.7 parts by mass or more and 20 parts by mass or less per 100 parts by mass of the food ingredient.
[5] The method according to any one of [1] to [4] above, wherein the coating treatment is performed through one or two processes selected from the group consisting of mixing and powder dredging.

### Advantageous Effects of Invention

The present invention is capable of suppressing coloring of an oil/fat composition for deep-frying upon deep-frying a food ingredient.

### DESCRIPTION OF EMBODIMENTS

A specific aspect for carrying out the present invention will be described. The following description, however, is only one of the aspects of the present invention and is not intended to limit the invention.

The present invention is a method for suppressing coloring of an oil/fat composition for deep-frying upon deep-frying a food ingredient (hereinafter, sometimes simply referred to as a “coloring suppressing method”), the method comprising a step of performing a coating treatment in which the food ingredient is coated with a coating agent containing a starch composition.

While the food ingredient is not particularly limited, examples thereof include meats, seafoods, vegetable proteins, vegetables, and processed products thereof. More specifically, one or two or more selected from the group consisting of: livestock meats, wild game meats, and poultry meats, such as pork, beef, chicken, goat meat, lamb/mutton, horse meat, boar meat, venison, rabbit meat, bear meat, wild duck meat, pigeon meat, duck meat, quail meat, and turkey; fish such as farmed salmon, sea bream, tuna, salmon, marlin, cod, bonito, and sardine; shrimp and prawns such as Alaskan pink shrimp, Japanese spiny lobster, and Japanese tiger prawn; crabs such as hair crabs, snow crabs, and red king crabs; squid and cuttlefish such as neon flying squid, swordtip squid, cuttlefish, Japanese common squid, firefly squid, and Japanese spear squid; octopuses such as ocellated octopus and octopus; shellfish such as oyster, scallop, abalone, clam, freshwater clam, spiny top shell, bloody clam, and hen clam; vegetable proteins such as soybean protein, pea protein, and wheat protein; vegetables such as onion, potato, pumpkin, sweet potato, asparagus, and tomato; and processed products thereof, can be used. Among them, livestock meats, vegetable proteins, and seafoods are preferable, and chicken, octopus, and oyster are more preferable.

The oil/fat composition for deep-frying is a heat medium generally used for deep-frying and is composed primarily of an edible oil/fat. Examples of edible oils/fats include vegetable oils/fats such as rapeseed oil, corn oil, soybean oil, palm olein, sesame oil, rice bran oil, peanut oil, safflower oil, sunflower oil, cottonseed oil, grape seed oil, macadamia nut oil, hazelnut oil, walnut oil, pumpkin seed oil, camellia oil, tea seed oil, olive oil, rice bran oil, wheat germ oil, palm oil, palm kernel oil, coconut oil, and cocoa oil; animal oils/fats such as tallow, lard, chicken fat, dairy fat, and fish oil; and synthetic oils/fats such as medium-chain fatty acid triglycerides. Alternatively, processed oils/fats, which are obtained by treating these oils/fats by one or two or more selected from hydrogenation, fractionation, and transesterification, can also be used. One or two or more of these edible oils/fats may be used alone or in mixture.

The oil/fat composition for deep-frying may contain, in addition to the edible oil/fat mentioned above, additives commonly added to frying oils. Examples of such additives include a silicone, an antioxidant, and an emulsifier. The content of the edible oil/fat in the oil/fat composition for deep-frying is preferably 80 mass % or more, more preferably 90 mass % or more, still more preferably 95 mass % or more, and particularly preferably 98 mass % or more.

The coating agent contains at least a starch composition. In addition, water, an edible oil/fat, seasonings, an emulsifier, an antioxidant, etc. may also be contained as long as the effect of the invention is not impaired.

Examples of the starch composition includes, but not particularly limited to, starch materials comprising raw starches and those obtained by subjecting the raw starches to one or two or more modification treatments selected from the group consisting of chemical modification, physical modification, or oil/fat modification. One or two or more starch materials may be used alone or in mixture.

More specifically, examples of the starch material include cornstarch, potato starch, tapioca starch, wheat starch, rice starch, sago starch, sweet potato starch, mung bean starch, pea starch, and modified starches thereof (e.g., those subjected to one or a combination of acetylation; etherification; and cross-linking such as phosphate cross-linking and adipate cross-linking), as well as those obtained by subjecting these raw material starches to the aforementioned modification treatment. Among these, an oil/fat-modified starch obtained by subjecting a raw material starch to oil/fat modification is preferable, and an oil/fat-modified starch obtained by subjecting a chemically modified starch to oil/fat modification is more preferable. Among others, it is preferable to use one or two starch materials selected from the group consisting of oil/fat-modified tapioca starch and oil/fat-modified cornstarch. Tapioca starch and cornstarch, which are raw materials of oil/fat-modified tapioca starch and oil/fat-modified cornstarch, can be either chemically unmodified or chemically modified starch, but preferably a chemically modified starch.

Moreover, the oil/fat-modified starch is preferably oil/fat-modified distarch phosphate tapioca starch, oil/fat-modified acetylated tapioca starch, or oil/fat-modified acetylated distarch phosphate tapioca starch, and more preferably oil/fat-modified acetylated tapioca starch or oil/fat-modified acetylated distarch phosphate tapioca starch.

The oil/fat-modified starch used in this embodiment refers to a starch material which is produced through a step in which one or two or more selected from the group consisting of edible oils/fats and edible oil/fat-related substances are added to a raw material starch, and then the resultant is mixed and heated.

Examples of the edible oil/fat as a raw material of the oil/fat-modified starch, include soybean oil, a safflower oil such as high-linoleic safflower oil, corn oil, rapeseed oil, perilla oil, linseed oil, sunflower oil, peanut oil, cotton seed oil, olive oil, rice oil, palm oil, coconut oil, sesame oil, camellia oil, tea oil, mustard oil, kapok oil, kaya oil, walnut oil, and poppy oil. It is more preferable to use an edible oil/fat having an iodine value of 100 or higher, and still more preferable to use an oil/fat having an iodine value of 140 or higher.

Specifically, examples of oils/fats having an iodine value of 140 or higher include high-linoleic safflower oil and linseed oil. More preferably, it is high-linoleic safflower oil.

Examples of the edible oil/fat-related substance include monoglycerol fatty acid esters; polyglycerol fatty acid esters; polyglycerol esters of interesterified ricinoleic acid; organic acid fatty acid esters; sucrose fatty acid esters; sorbitan fatty acid esters; polysorbates; and phospholipids. In this embodiment, polyglycerol fatty acid esters are preferred, and diglycerol monooleate esters are more preferred.

Here, the quantity of the edible oil/fat or edible oil/fat-related substance blended upon preparing an oil/fat-modified starch may be, for example, such that the total quantity of the edible oil/fat and edible oil/fat-related substance is 0.005 parts by mass or more, more preferably 0.008 parts by mass or more, and still more preferably 0.2 parts by mass or more, relative to 100 mass parts of the raw material starch. Also, the quantity of the edible oil/fat or edible oil/fat-related substance blended is, for example, such that the total quantity of the edible oil/fat and edible oil/fat-related substance is 2 parts by mass or less, more preferably 1.5 part by mass or less, and still more preferably 0.8 parts by mass or less, relative to 100 mass parts of the raw material starch.

Moreover, the quantity of the edible oil/fat or edible oil/fat-related substance blended upon preparing an oil/fat-modified starch may be, for example, such that the total quantity of the edible oil/fat and edible oil/fat-related substance is 0.005 parts by mass or more and 2 parts by mass or less, more preferably 0.008 parts by mass or more and 1.5 parts by mass or less, and still more preferably 0.2 parts by mass or more and 0.8 parts by mass or less, relative to 100 mass parts of the raw material starch.

Whenever a numerical range is indicated herein, the upper and lower limit values can be combined as appropriate, and any numerical range obtained thereby is considered to be disclosed herein.

When one or two or more selected from the group consisting of edible oils/fats and edible oil/fat-related substances are added to and mixed with a raw material starch and the resulting mixture is heated, the heating temperature is not particularly limited, but usually the temperature of the mixture is preferably 50° C. or higher and 200° C. or lower, more preferably 50° C. or higher and 150° C. or lower, still more preferably 50° C. or higher and 100° C. or lower, and yet still more preferably 60° C. or higher and 80° C. or lower. While the heating time is not particularly limited, it is usually not less than 1 hour and not more than 3 weeks, and more preferably not less than 2 hours and not more than 2 weeks. For example, a process for oil/fat modification in which the above mixture is heated up to 150° C. and held for 2-3 hours, a process for oil/fat modification in which the above mixture is heated up to 70° C. and held for 2 weeks, or the like can be employed.

The above-mentioned coating agent preferably contains the starch composition in a quantity of 0.7 parts by mass or more and 20 parts by mass or less, more preferably 1 parts by mass or more and 18 parts by mass or less, and still more preferably 1 parts by mass or more and 15 parts by mass or less per 100 parts by mass of a food ingredient. By preparing the coating agent so that the mass ratio of the starch composition to the food ingredient is within the above range and by coating the food ingredient with the coating agent through a coating treatment, coloring of the oil/fat composition can be suppressed more effectively.

In addition, the content of the starch composition in the above coating agent is preferably 20 mass % or more, more preferably 25 mass % or more, and still more preferably 30 mass % or more. In one aspect of the invention, the content of the starch composition in the above coating agent may be, for example, 40 mass % or more, 50 mass % or more, 60 mass % or more, 70 mass % or more, 80 mass % or more, or 90 mass % or more. There is no particular upper limit and the content is 100 mass % or less. The content of the starch composition in the above coating agent can be selected appropriately according to the form of the coating agent.

It is preferable that the quantity of the above coating agent coating the food ingredient is 0.5 parts by mass or more and 20 parts by mass or less, more preferably 1 parts by mass or more and 20 parts by mass or less, and still more preferably 1 parts by mass or more and 15 parts by mass or less per 100 parts by mass of the food ingredient.

While the form of the above coating agent is not particularly limited, it is preferably in a form that can be coated over the surface of the food ingredient. Preferably, it is in a form of powder, liquid, or slurry.

The coating treatment can be any means for coating the surface of the food ingredient with the coating agent, where examples of such means include “rubbing”, “powder dredging”, “mixing”, and “tumbling”, preferably one or two or more selected from the group consisting of “rubbing”, “powder dredging”, and “mixing”, and more preferably one or two selected from the group consisting of “mixing” and “powder dredging”.

Each coating method will be described in detail.
“Rubbing” is a process in which the food ingredient and the coating agent are put into a container to coat the surface of the food ingredient with the coating agent by rubbing the food ingredient by hand or using a special machine.
“Powder dredging” is a process in which part or the entire surface of the food ingredient is dredged in the powdered coating agent to coat the surface of the food ingredient with the coating agent.
“Mixing” is a process in which the food ingredient and the coating agent are put into a container to coat the surface of the food ingredient with the coating agent by stirring by hand or using a special machine.
“Tumbling” is a method in which the food ingredient and the coating agent are enclosed in a container to coat the surface of the food product with the coating agent by beating the food ingredient by hand or using a special machine.

Now, it is not necessary to coat the entire surface of the food ingredient with the coating agent, and there may be portions of the surface of the food ingredient where it is not coated with the coating agent as long as the effect of the invention can be achieved.

Deep-frying is a heat cooking process that uses a relatively large quantity of oil/fat composition as the heat medium. While the process of frying is not particularly limited, it may be, for example, a process of heat cooking the food ingredient by immersing the food ingredient in the oil/fat composition heated to a temperature of 140° C. or higher and 200° C. or lower for a predetermined period of time. Deep-frying can give, for example, crumb-fried food, deep-fried seasoned food, tempura batter-fried food, batter-fried food, and the like.

According to such a coloring suppressing method of the present invention, coloring of an oil/fat composition for deep-frying upon deep-frying a food ingredient can be suppressed. In addition, by coating the food ingredient with a coating agent containing a specific starch composition, juicy and tender deep-fried foods can be obtained.

### EXAMPLES

Hereinafter, examples of the coloring suppressing method of the present invention will be described.

First, the color difference, acid value, and rate of increase in viscosity of the oil/fat compositions for deep-frying in the following examples will be described.

### Method for Determining Color Difference

Color difference was determined according to The JOCS Standard Methods for the Analysis of Fats, Oils and Related Materials (2.2.1.1₋₂₀₁₃ Color (Lovibond Method)). More specifically, the Y+10R+20B value was determined with a Lovibond tintometer (PFX990 manufactured by The Tintometer Ltd.) using a 1-inch cell.

### Method for Determining Acid Value

Acid value was determined according to The JOCS Standard Methods for the Analysis of Fats, Oils and Related Materials (2.3.1₋₂₀₁₃ Acid Value).

### Method for Measuring Viscosity

The rate of increase in viscosity was determined by measuring the viscosity using a corn-plate viscometer (TV-20 manufactured by TOKIMEC INC.) at 30° C. and 100 rpm for 2 min., and then calculating the value in comparison with the viscosity of new oil.

Furthermore, materials used for the coating agents and the oil/fat composition for deep-frying in the examples will be described.

### Materials for Coating Agents

### Starches

Oil/fat-modified acetylated tapioca starch:. K-1 manufactured by Nihon Shokuhin Kako Co., Ltd.
Oil/fat-modified distarch phosphate tapioca starch: KT-10 manufactured by J-OIL MILLS
Pregelatinized high-amylose cornstarch: JELCALL AH-F manufactured by J-OIL MILLS
Cornstarch: Cornstarch Y manufactured by J-OIL MILLS
Weak flour: Heart manufactured by Nippon Flour Mills Co. Ltd.

### Additives

Starch sodium octenyl succinate: N-Creamer 46 manufactured by Nippon NSC, Japan

### Oil/Fat Composition for Deep-Frying

Rapeseed oil: Sarasara Canola Oil manufactured by J-OIL MILLS (viscosity of new oil: 47.0 mPa·s)

Methods for visual and sensory evaluations employed in the examples will be described.

### Visual Evaluation

For visual evaluation, five expert panelists visually evaluated the coloring of the oil/fat compositions for deep-frying and the degree of generation of fry debris upon deep-frying, and the results were obtained by consensus.

### Sensory Evaluation

For sensory evaluation, five expert panelists ate the 45th piece of the deep-fried foods and evaluated the juiciness and tenderness of meat in comparison with the control.

### Example 1

In Example 1, coating agents prepared in the formulation shown in Table 1 were used to perform the coating treatment of chicken thigh meat by mixing, and the resultants were deep-fried. The detailed process of cooking will be described below. Color difference, acid values, rates of increase in viscosity, visual evaluations of the oil/fat compositions for deep-frying after deep-frying, and sensory evaluations of the deep-fried seasoned foods are shown in Table 1.

### Cooking Process

(1) Frozen chicken thigh meat was placed in the refrigerator overnight to thaw.
(2) Skin was removed from the chicken thigh meat and the chicken thigh meat was cut into 28-32 g/piece.
(3) 1,350 g of chicken thigh meat and 540 g of pickle brine shown in Table 1 were tumbled in a tumbler (MODEL F-15 manufactured by Flavor Maker).
(4) Starch and additives were mixed in the formulation shown in Table 1 to obtain a coating agent.
(5) Chicken thigh meat was removed from the tumbler, to which the coating agent obtained in (4) was added and mixed by hand for 3 minutes to perform the coating treatment. At this point, the quantity of the coating agent applied averaged 3 parts by mass per 100 parts mass of the chicken thigh meat.
(6) Chicken thigh meat that had undergone the coating treatment was dipped into a batter solution made by mixing seasoned fry mix powder (Chubo-Ou Juicy Seasoned Fry Mix Powder manufactured by Daisho Co., Ltd.) with an equal quantity of cold water.
(7) 900 g of oil/fat composition for deep-frying was poured in a 1 L stainless steel pot. Once the temperature of the oil/fat composition for deep-frying reached 170° C., 5 pieces of chicken thigh meat were put in the pot and heat cooked for 5 minutes to obtain deep-fried seasoned foods.
(8) The process in (7) was performed until 45 pieces were deep-fried.

TABLE 1

| Quantity blended per 100 parts by mass of food ingredient | | | Comparative example 1-1 | Example 1-1 | Example 1-2 |
|---|---|---|---|---|---|
| Oil/fat composition for deep-frying | | | Rapeseed oil | | |
| Food ingredient | | | Chicken thigh meat | | |
| Pickle brine [Parts by mass] | | Caster sugar | 1.6 | | |
| | | Salt | 0.8 | | |
| | | Sodium glutamate | 0.56 | | |
| | | White pepper | 0.064 | | |
| | | Soy sauce | 4 | | |
| | | Grated garlic | 1.6 | | |
| | | Grated ginger | 1.6 | | |
| | | Ice water | 29.776 | | |
| Coating agent | Starch | Oil/fat-modified acetylated | | 5 | |
| | [Parts by | tapioca starch | | | |
| | mass] | Cornstarch | | | 5 |
| | Additive | Starch sodium octenyl | | 0.1 | |
| | [Parts by | succinate | | | |
| | mass] | | | | |

| Color difference | New oil | 6.0 | | |
|---|---|---|---|---|
| (Y + 10R + 20B) | After deep-frying 45 pieces | 18.2 | 8.00 | 13.3 |
| Acid value | New oil | 0.04 | | |
| | After deep-frying 45 pieces | 0.12 | 0.10 | 0.11 |
| Rate of increase in viscosity | After deep-frying 45 pieces | 0.8 | 1.3 | 1.0 |
| [%] | | | | |
| Visual evaluation of frying | After deep-frying 5 pieces | A small amount of fry | Equivalent to new | Equivalent to new |
| oil (comments) | | debris was generated | oil | oil |
| | After deep-frying 15 pieces | Coloring was observed | Equivalent to new | Equivalent to new |
| | | A large amount of fry | oil | oil |
| | | debris was generated | | |
| | After deep-frying 25 pieces | Coloring was observed | Slight coloring was | Slight coloring |
| | | A large amount of fry | observed | was observed |
| | | debris was generated | | |
| | After deep-frying 45 pieces | Severe coloring was | Slight coloring was | Slight coloring |
| | | observed | observed | was observed |
| | | Fry debris was generated | | A small amount of |
| | | to a degree where oil | | fry debris was |
| | | looked cloudy | | generated |

| | | | |
|---|---|---|---|
| Sensory evaluation of food products (comments) | Control | Meat was tender, | Drier than control |
| | | juicy and tasty | |
| | | compared to control | |

As shown in Table 1, the oil/fat compositions for deep-frying in Examples 1-1 and 1-2, in which the food ingredient was deep-fried after being coated with the coating agent containing oil/fat-modified acetylated tapioca starch or cornstarch, had a smaller color difference than the oil/fat composition for deep-frying in Comparative example 1-1, in which the food ingredient was deep-fried without being coated with the coating agent, and visual evaluation also showed that coloring and generation of fry debris were suppressed. In addition, the deep-fried seasoned food in Example 1-1, which was deep-fried after being coated with the coating agent containing oil/fat-modified acetylated tapioca starch, had juicier and tenderer meat texture than the control deep-fried seasoned food.

### Example 2

In Example 2, coating agents prepared in the formulation shown in Table 2 were used to perform the coating treatment of octopus by mixing, and the resultants were deep-fried. The detailed process of cooking will be described below. Color difference, acid values, rates of increase in viscosity, visual evaluations of the oil/fat compositions for deep-frying after deep-frying, and sensory evaluations of the deep-fried seasoned octopus are shown in Table 2.

### Cooking Process

(1) Frozen octopus was thawed overnight in the refrigerator, and lightly rinsed with water to remove slime and debris.
(2) The octopus was cut into 10-15 g/piece.
(3) The coating agent was added to 1,000 g of octopus and mixed by hand for 3 minutes to perform the coating treatment. At this point, the quantity of the coating agent applied averaged 2 parts by mass per 100 parts mass of the octopus.
(4) Octopus that had undergone the coating treatment was dipped into a batter solution made by mixing seasoned fry mix powder (Chubo-Ou Juicy Seasoned Fry Mix Powder manufactured by Daisho Co., Ltd.) with an equal quantity of cold water.
(5) 900 g of oil/fat composition for deep-frying was poured in a 1 L stainless steel pot. Once the temperature of the oil/fat composition for deep-frying reached 170° C., 5 pieces of octopus were put in the pot and heat cooked for 3 minutes to obtain deep-fried seasoned octopus.
(6) The process in (5) was performed until 80 pieces were deep-fried.

TABLE 2

| Quantity blended per 100 parts by mass of food ingredient | | | Comparison example 2-1 | Example 2-1 |
|---|---|---|---|---|
| Oil/fat composition for deep-frying | | | Rapeseed oil | |
| Food ingredient | | | Octopus | |
| Coating agent | Starch | Oil/fat-modified distarch | | 3 |
| | [Parts by | phosphate tapioca starch | | |
| | mass] | | | |

| Color difference | New oil | 6.0 | |
|---|---|---|---|
| (Y + 10R + 20B) | After deep-frying 80 | 40.0 | 34.0 |
| | pieces | | |
| Acid value | New oil | 0.04 | |
| | After deep-frying 80 | 0.16 | 0.16 |
| | pieces | | |
| Rate of increase in viscosity [%] | After deep-frying 80 | 2.3 | 2.8 |
| | pieces | | |
| Visual evaluation of frying oil | After deep-frying 5 | Slight coloring was | Equivalent |
| (comments) | pieces | observed | to new oil |
| | After deep-frying 15 | Coloring was observed | Slight |
| | pieces | | coloring was |
| | | | observed |
| | After deep-frying 45 | Coloring was observed | Slight |
| | pieces | Fry debris was generated | coloring was |
| | | | observed |
| | After deep-frying 80 | Severe coloring was | Slight |
| | pieces | observed | coloring was |
| | | Fry debris was generated | observed |
| | | to a degree where oil | A small |
| | | looked cloudy | amount of |
| | | | fry debris |
| | | | was |
| | | | generated |

| | | |
|---|---|---|
| Sensory evaluation of food products (comments) | Control | Meat was |
| | | tender and |
| | | could be |
| | | bitten off |
| | | easily |
| | | compared to |
| | | control |

As shown in Table 2, the oil/fat composition for deep-frying in Example 2-1, in which the food ingredient was deep-fried after being coated with the coating agent containing oil/fat-modified distarch phosphate tapioca starch, had a smaller color difference than the oil/fat composition for deep-frying in Comparative example 2-1, in which the food ingredient was deep-fried without being coated with the coating agent, and visual evaluation also showed that coloring and generation of fry debris were suppressed. In addition, the deep-fried seasoned octopus in Example 2-1, which was deep-fried after being coated with the coating agent containing oil/fat-modified distarch phosphate tapioca starch, had tenderer meat texture and could be bitten off more easily than the control deep-fried seasoned octopus.

### Example 3

In Example 3, coating agents prepared in the formulation shown in Table 3 were used to perform the coating treatment of chicken thigh meat by mixing, and the resultants were deep-fried. The detailed process of cooking will be described below. Color difference, acid values, rates of increase in viscosity, visual evaluations of the oil/fat compositions for deep-frying after deep-frying, and sensory evaluations of the deep-fried seasoned foods are shown in Table 3.

### Cooking Process

(1) Frozen chicken thigh meat was placed in the refrigerator overnight to thaw.
(2) Skin was removed from the chicken thigh meat and the chicken thigh meat was cut into 28-32 g/piece.
(3) 1,350 g of chicken thigh meat and 540 g of pickle brine shown in Table 3 were tumbled in a tumbler (MODEL F-15 manufactured by Flavor Maker).
(4) Starch and additives were mixed in the formulation shown in Table 3 to obtain a coating agent.
(5) Chicken thigh meat was removed from the tumbler and place them in a bowl, to which the coating agent obtained in (4) was added and mixed using a mixing machine (N50 manufactured by Hobart Japan) at 1st speed for 3 minutes using a flat beater to perform the coating treatment. At this point, the quantity of the coating agent applied averaged 3 parts by mass per 100 parts mass of the chicken thigh meat.
(6) Chicken thigh meat that had undergone the coating treatment were dipped into a batter solution made by mixing seasoned fry mix powder (Chubo-Ou Juicy Seasoned Fry Mix Powder manufactured by Daisho Co., Ltd.) with an equal quantity of cold water.
(7) 900 g of oil/fat composition for deep-frying was poured in a 1 L stainless steel pot. Once the temperature of the oil/fat composition for deep-frying reached 170° C., 5 pieces of chicken thigh meat were put in the pot and heat cooked for 5 minutes to obtain deep-fried seasoned foods.
(8) The process in (7) was performed until 100 pieces were deep-fried.

TABLE 3

| Quantity blended per 100 parts by mass of food | | | | |
|---|---|---|---|---|
| ingredient | | | Comparison example 3-1 | Example 3-1 |
| Oil/fat composition for deep-frying | | | Rapeseed oil | |
| Food ingredient | | | Chicken thigh meat | |
| Pickle brine [Parts | | Caster sugar | 1.6 | |
| by mass] | | Salt | 0.8 | |
| | | Sodium glutamate | 0.56 | |
| | | White pepper | 0.064 | |
| | | Soy sauce | 4 | |
| | | Grated garlic | 1.6 | |
| | | Grated ginger | 1.6 | |
| | | Ice water | 29.776 | |
| Coating | Starch | Oil/fat-modified | | 3.4 |
| agent | [Parts by | acetylated tapioca starch | | |
| | mass] | Pregelatinized high- | | 1.4 |
| | | amylose cornstarch | | |
| | Additive | Starch sodium octenyl | | 0.3 |
| | [Parts by | succinate | | |
| | mass | | | |

| Color difference | New oil | 6.0 | |
|---|---|---|---|
| (Y + 10R + 20B) | After deep-frying 45 | 33.0 | 20.5 |
| | pieces | | |
| | After deep-frying 100 | 105.0 | 59.0 |
| | pieces | | |
| Acid value | New oil | 0.04 | |
| | After deep-frying 45 | 0.17 | 0.16 |
| | pieces | | |
| | After deep-frying 100 | 0.34 | 0.28 |
| | pieces | | |
| Rate of increase in | After deep-frying 45 | 2.8 | 2.3 |
| viscosity [%] | pieces | | |
| | After deep-frying 100 | 4.6 | 6.8 |
| | pieces | | |
| Visual evaluation | After deep-frying 5 | A small amount of fry debris was | Equivalent to new oil |
| of frying oil | pieces | generated | |
| (comments) | After deep-frying 15 | Coloring was observed | Equivalent to new oil |
| | pieces | A large amount of fry debris was | |
| | | generated | |
| | After deep-frying 25 | Coloring was observed | Slight coloring was |
| | pieces | A large amount of fry debris was | observed |
| | | generated | |
| | After deep-frying 45 | Severe coloring was observed | Slight coloring was |
| | pieces | Fry debris was generated to a degree | observed |
| | | where oil looked cloudy | |
| | After deep-frying 70 | Severe coloring was observed | Coloring was observed |
| | pieces | Fry debris was generated to a degree | A small amount of fry |
| | | where oil looked cloudy | debris was generated |
| | After deep-frying 100 | Severe coloring was observed | Coloring was observed |
| | pieces | Fry debris was generated to a degree | A small amount of fry |
| | | where oil looked cloudy | debris was generated |

| | | |
|---|---|---|
| Sensory evaluation of food products (comments) | Control | Meat was tender, juicy and |
| | | tasty compared to control |

As shown in Table 3, the oil/fat composition for deep-frying in Example 3-1, in which the food ingredient was deep-fried after being coated with the coating agent containing oil/fat-modified acetylated tapioca starch and pregelatinized high-amylose cornstarch, had a smaller color difference than the oil/fat composition for deep-frying in Comparative example 3-1, in which the food ingredient was deep-fried without being coated with the coating agent, and visual evaluation also showed that coloring and generation of fry debris were suppressed both after deep-frying 45 pieces and after deep-frying 100 pieces. In addition, the deep-fried seasoned food in Example 3-1, which was deep-fried after being coated with the coating agent containing oil/fat-modified acetylated tapioca starch and pregelatinized high-amylose cornstarch, had juicier and tenderer meat texture than the control deep-fried seasoned food.

### Example 4

In Example 4, coating agents prepared in the formulation shown in Table 4 were used to perform the coating treatment of oysters by powder dredging, and the resultants were deep-fried. The detailed process of cooking will be described below. Color difference, acid values, rates of increase in viscosity, visual evaluations of the oil/fat compositions for deep-frying after deep-frying, and sensory evaluations of the deep-fried seasoned foods are shown in Table 4. The symbol “-” in the table indicates that it has not been evaluated.

### Cooking Process

(1) Frozen oysters were lightly rinsed in water to remove the ice on the surface.
(2) Oysters (20-25 g/piece) were dredged evenly in a powdered coating agent, and excess coating agent was removed with a brush to perform the coating treatment. At this point, the quantity of the coating agent applied averaged 6 parts by mass per 100 parts mass of oyster.
(3) After the oysters were dipped into liquid whole egg, fresh breadcrumbs (manufactured by Fuji Panko Kogyo Co., Ltd.) were applied to the entire surface.
(4) 900 g of oil/fat composition for deep-frying was poured in a 1 L stainless steel pot. Once the temperature of the oil/fat composition for deep-frying reached 170° C., 5 oysters were put in the pot and heat cooked for 5 minutes to obtain crumb-fried seasoned oysters.
(5) The process in (4) was performed until 20 pieces were deep-fried in Comparative example 4-1 and Example 4-1, and until 40 pieces were deep-fried in Comparative example 4-2 and Example 4-2.

TABLE 4

| Quantity blended per 100 parts by mass of | | | Comparative | | Comparative | |
|---|---|---|---|---|---|---|
| food ingredient | | | example 4-1 | Example 4-1 | example 4-2 | Example 4-2 |
| Oil/fat composition for deep-frying | | | Rapeseed oil | | | |
| Food ingredient | | | Oyster | | | |
| Coating | Starch | Weak flour (Cake | 6 | | 6 | |
| agent | [Parts | flour) | | | | |
| | by | Oil/fat-modified | | 6 | | 6 |
| | mass] | distarch phosphate | | | | |
| | | tapioca starch | | | | |
| Color difference | | New oil | 6.0 | | | |
| (Y + 10R + 20B) | | After deep-frying 20 | 31.0 | 23.8 | — | — |
| | | pieces | | | | |
| | | After deep-frying 40 | — | — | 97.0 | 92.0 |
| | | pieces | | | | |
| Acid value | | New oil | 0.04 | | | |
| | | After deep-frying 20 | 0.11 | 0.10 | — | — |
| | | pieces | | | | |
| | | After deep-frying 40 | — | — | 0.13 | 0.13 |
| | | pieces | | | | |
| Rate of increase in | | After deep-frying 20 | 0.0 | 0.4 | — | — |
| viscosity [%] | | pieces | | | | |
| | | After deep-frying 40 | — | — | 0.0 | 0.4 |
| | | pieces | | | | |
| Visual evaluation of | | After deep-frying 5 | Coloring was | Slight coloring was | Coloring was | Slight coloring |
| frying oil | | pieces | observed | observed | observed | was observed |
| (Comments) | | After deep-frying 20 | Significant | Coloring was | Significant | Coloring was |
| | | pieces | coloring was | observed, but color | coloring was | observed |
| | | | observed | was lighter than that | observed | |
| | | | Fry debris was | in Comparative | Fry debris was | |
| | | | generated | example 4-1 | generated | |
| | | After deep-frying 30 | — | — | Severe coloring | Coloring was |
| | | pieces | | | was observed | observed |
| | | | | | Fry debris was | A small amount of |
| | | | | | generated to a | fry debris was |
| | | | | | degree where oil | generated |
| | | | | | looked cloudy | |
| | | After deep-frying 40 | — | — | Severe coloring | Coloring was |
| | | pieces | | | was observed | observed |
| | | | | | Fry debris was | A small amount of |
| | | | | | generated to a | fry debris was |
| | | | | | degree where oil | generated |
| | | | | | looked cloudy | |

| | | | | |
|---|---|---|---|---|
| Sensory evaluationof food products | Control 4-1 | Oyster was fresh | Control 4-2 | Oyster was fresh |
| (comments) | | and juicy compared | | and juicy |
| | | to Control 4-1 | | compared to |
| | | Texture of the meat | | Control 4-2 |
| | | was also plump | | Texture of the |
| | | | | meat was plump |

As shown in Table 4, the oil/fat compositions for deep-frying in Examples 4-1 and 4-2, in which the food ingredients were deep-fried after being coated with the coating agent containing oil/fat-modified distarch phosphate tapioca starch, had a smaller color difference than the oil/fat compositions for deep-frying in Comparative examples 4-1 and 4-2, respectively, in which the food ingredients were deep-fried after being coated with weak flour, and visual evaluation also showed that coloring and generation of fry debris were suppressed. In addition, the crumb-fried oysters in Examples 4-1 and 4-2, which was deep-fried after being coated with the coating agent containing oil/fat-modified distarch phosphate tapioca starch, had more fresh, juicier and more plump oyster texture than those in Controls 4-1 and 4-1, respectively.

### Example 5

In Example 5, coating agents shown in Table 5 were prepared and used to perform the coating treatment on chicken thigh meat by mixing, and the resultants were deep-fried. The detailed process of cooking will be described below. Color difference and acid values of the oil/fat compositions for deep-frying after deep-frying are shown in Table 5.

### Cooking Process

(1) Frozen chicken thigh meat was placed in the refrigerator overnight to thaw.
(2) Skin was removed from the chicken thigh meat and the chicken thigh meat was cut into 20-25 g/piece.
(3) 8,000 g of chicken thigh meat and 1,600 g of pickle brine shown in Table 1 were tumbled in a tumbler (“ESK-60” manufactured by VAKONA GmbH).
(4) The coating agents shown in Table 5 were prepared. Coating agents 1 and 2 were prepared as described below.
(5) When the amount of the pickle brine became small, the coating agent in (4) was put into the tumbler to perform the coating treatment by mixing. The quantity of the coating agent added was adjusted to average 5 parts by mass per 100 parts mass of the chicken thigh meat.
(6) Coated meat was frozen.
(7) 3,000 g of oil/fat composition for deep-frying was poured in a 3 L commercial deep-fryer manufactured by MACH Electric Cooker. Once the temperature of the oil/fat composition for deep-frying reached 180° C., 400 g of the chicken thigh meat obtained in (6) were put in the fryer and heat cooked for 5 minutes and 30 seconds to obtain crumb-fried foods. The chicken thigh meat obtained in (6) was placed in the refrigerator to thaw the day before deep-frying.
(8) The process in (7) was performed 5 times a day using the same oil/fat composition for deep-frying, where the time of heating the oil/fat composition for deep-frying was 8 hours per day.
(9) The process in (8) was performed for 5 days to evaluate the oil/fat composition for deep-frying after use.

### Coating Agent 1

60 parts by weight of acetylated distarch phosphate tapioca starch A (“ACTBODY ATP-25” manufactured by J-OIL MILLS) and 40 parts by weight of acetylated distarch phosphate tapioca starch B (“ACTBODY ATP-27” manufactured by J-OIL MILLS) were mixed to obtain a starch mixture. 99.55 parts by mass of this starch mixture, 0.1 parts by mass of high-linoleic safflower oil, 0.05 parts by mass of diglycerol monooleate ester

(“Rikemal JV-2681” manufactured by RIKEN VITAMIN Co., Ltd.), and 0.3 parts by mass of trisodium citrate were mixed homogeneously in a mixer (Super mixer manufactured by Kawata MFG Co., Ltd.) at 2,000 rpm for 3 minutes, and the resultant was heated in a shelf dryer at 70° C. for 11 days to obtain Coating agent 1.

### Coating Agent 2

99 parts by mass of Coating agent 1 and 1 part by mass of polysaccharide thickener (“Xanthan gum FJ” manufactured by Jungbunzlauer Austria AG) were mixed homogeneously in a mixer (Super mixer manufactured by Kawata MFG Co., Ltd.) at 2,000 rpm for 3 minutes to obtain Coating agent 2.

TABLE 5

| | Time of continuous heating | Color difference | Acid |
|---|---|---|---|
| | [Hour] | (Y + 10R + 20B) | value |
| Rapeseed oil | 0 | 1.9 | 0.04 |
| (New oil) | | | |
| Control 5: | 10 | 37 | 0.18 |
| No coating agent | 20 | 141 | 0.35 |
| | 30 | 204 | 0.57 |
| | 39 | 322.5 | 0.76 |
| Example 5-1: | 10 | 22.3 | 0.16 |
| Cornstarch | 20 | 79 | 0.32 |
| | 30 | 156 | 0.53 |
| | 39 | 194 | 0.74 |
| Example 5-2: | 10 | 22.3 | 0.17 |
| Coating agent 1 | 20 | 75 | 0.32 |
| | 30 | 151 | 0.52 |
| | 39 | 191 | 0.71 |
| Example 5-3: | 10 | 20.4 | 0.16 |
| Coating agent 2 | 20 | 73 | 0.31 |
| | 30 | 154 | 0.49 |
| | 39 | 191 | 0.67 |

As shown in Table 5, the oil/fat compositions for deep-frying in Examples 5-1 to 5-3, in which the food ingredients were deep-fried after being coated with cornstarch, Coating agent 1 or Coating agent 2, respectively, each had a smaller color difference than the oil/fat composition for deep-frying in Control 5, in which the food ingredient was deep-fried without the coating agent, and coloring was suppressed. The effect of suppressing coloring of the oil/fat compositions for deep-frying was particularly remarkable when Coating agent 1 and Coating agent 2, i.e., oil/fat-modified starches, were used (Examples 5-2 and 5-3).

The acid values of the oil/fat compositions for deep-frying in Examples 5-1 to 5-3 were also lower than that of the oil/fat composition for deep-frying in Control 5.

These results show that the use of the method of the present invention, in which food ingredients are coated with a coating agent, can suppress coloring and increase in acid value of an oil/fat composition for deep-frying.

The coloring suppressing method according to the present invention is not limited to the embodiments and examples described above, and various modifications can be made as long as they do not impair the effect of the invention.

1. A method for suppressing coloring of an oil/fat composition for deep-frying upon deep-frying a food ingredient, the method comprising a step of:
performing a coating treatment in which the food ingredient is coated with a coating agent containing a starch composition.

2. The method according to claim 1, wherein the starch composition comprises an oil/fat-modified starch.

3. The method according to claim 2, wherein the oil/fat-modified starch is one or two or more selected from the group consisting of an oil/fat-modified distarch phosphate tapioca starch, oil/fat-modified acetylated tapioca starch, and oil/fat-modified acetylated distarch phosphate tapioca starch.

4. The method according to claim 1, wherein the coating agent comprises the starch composition in a quantity of 0.7 parts by mass or more and 20 parts by mass or less per 100 parts by mass of the food ingredient.

5. The method according to claim 1, wherein the coating treatment is performed through one or two selected from the group consisting of mixing and powder dredging.

6. The method according to claim 2, wherein the coating agent comprises the starch composition in a quantity of 0.7 parts by mass or more and 20 parts by mass or less per 100 parts by mass of the food ingredient.

7. The method according to claim 3, wherein the coating agent comprises the starch composition in a quantity of 0.7 parts by mass or more and 20 parts by mass or less per 100 parts by mass of the food ingredient.

8. The method according to claim 2, wherein the coating treatment is performed through one or two selected from the group consisting of mixing and powder dredging.

9. The method according to claim 3, wherein the coating treatment is performed through one or two selected from the group consisting of mixing and powder dredging.

10. The method according to claim 4, wherein the coating treatment is performed through one or two selected from the group consisting of mixing and powder dredging.

11. The method according to claim 6, wherein the coating treatment is performed through one or two selected from the group consisting of mixing and powder dredging.

12. The method according to claim 7, wherein the coating treatment is performed through one or two selected from the group consisting of mixing and powder dredging.
